(19) United States
(12) Patent Application Publication
(10) Pub. No.: US 2004/0147269 A1
(43) Pub. Date: Jul. 29, 2004

(54) Wireless communication system for getting location information of a wireless mobile station and method thereof

(75) Inventor: Hak-Soo Kim, Suwon-shi (KR)

Correspondence Address: Frank Chau, F. CHAU & ASSOCIATES, LLP, Suite 501, 1900 Hempstead Turnpike, East Meadow, NY, 11554, US

(73) Assignee: Samsung Electronics Co., Ltd.

(21) Appl. No.: 10/735,979

(22) Filed: Dec. 15, 2003

(30) Foreign Application Priority Data
Jan. 29, 2003 (KR) 2003-05837

(51) Int. Cl. H04Q 7/20

(52) U.S. Cl. 455/456.2

(57) ABSTRACT

A wireless communication system comprises a wireless mobile station and a wireless base station for communicating with the wireless mobile station through a wireless communication network, wherein the wireless mobile station requests location information from the wireless base station. The wireless base station transmits the location information to the wireless mobile station in response to the request of the wireless mobile station. Although the mobile station is placed in the environment in which it is difficult to receive a satellite signal or the mobile station does not include a satellite signal receiver, the location of the mobile station can be determined through the base station that can always receive a satellite signal.

### BACKGROUND OF THE INVENTION

1. Field of the Invention

The present invention relates to a wireless communication system, and more particularly, to a wireless communication system capable of determining location information of a wireless mobile station and method thereof.

2. Description of the Related Art

The Global Positioning System (GPS) utilizes various technologies, which are implemented by different components. Macroscopically these components can be classified into three segments, e.g., a space segment, a control segment, and a user segment.

The space segment includes GPS satellites for continually transmitting navigation data needed to determine a position of a GPS receiver through a carrier. The carrier comprises a signal(s) having a frequency L1 (1,575.42 MHz) and/or L2 (1,227.6 MHz) in the L-band transmitted to the GPS receiver. Four GPS satellites are disposed on each of six circular orbits whose inclination angle is 55°. Each GPS satellite is disposed in an orbit 26,567.5 Km from the center of the Earth, and has a period of about twelve hours. The positioning of the GPS satellites is designed specially so that the signals of at least four satellites are accessible from any position on the Earth to determine a 3-dimensional location of the GPS receiver and a receiver clock error. The satellite data transmitted from each GPS satellite includes a pseudo random noise (PRN) code unique to each satellite. Since the GPS satellite data is transmitted to the GPS receiver with code division multiple access (CDMA), the GPS receiver can receive navigation data corresponding to each satellite. According to the GPS modernization plan, an L5 frequency will be added for private use in addition to the L1 and L2 frequencies.

The control segment monitors the GPS satellites with various control stations, tracking the location of the GPS satellites and transmits various correction information to the GPS satellites. The correction information is transmitted to the GPS receiver continuously as a piece of navigation data. The GPS satellite control station comprises five monitor stations, four ground antenna upload stations, and an operational control station.

The user segment comprises a GPS receiver for receiving a GPS satellite signal and determining a location of the GPS receiver. The use segment can also comprise equipment developed to adapt the GPS receiver for achieving a special purpose. The GPS receiver determines its location and speed by using the navigation data received from the GPS satellite. The GPS receiver tracks the GPS satellite signal with a built-in algorithm and the navigation data. If one satellite signal is tracked, the information on the relative location of another satellite can be obtained, so that all the accessible satellite signals can be tracked. The location and speed information that the GPS receiver determined after receiving the GPS satellite signal is used for navigation and tracking. The clock error of the GPS receiver, determined, with μs precision, is used as information for time synchronization in mobile communication. The satellite navigation system can be adapted for airplane automatic landing systems needing high position precision, land surveys, attitude determination, general navigation system, etc.

However, the GPS receiver cannot receive the satellite signals indoors. Since a typical signal transmitted from a GPS satellite travels about 25,000 Km, its intensity is so weak that it cannot penetrate structures. A GPS antenna of the GPS receiver needs a clear path to the GPS satellite.

A Wireless Local Area Network (WLAN) is a local area network (LAN) using no wire. WLAN technology is wide spread. The WLAN transmits data by using radio frequencies instead of cables. The transmission radius of a WLAN transmitter is about 500 or 1000 ft. Antennae, transmitters and other connection devices support the use of WLAN within that radius.

The WLAN needs a wired access point (AP) in which wireless devices are connected to a wired network. A WLAN standard has been suggested by Institute of Electrical and Electronics Engineers (IEEE) called 802.11b or Wi-Fi. Because of the standardization, WLAN is expected to grow rapidly.

WLAN is used on campuses, in company buildings, apartments, and airports. This allows users to access an Internet connection portal. Bluetooth and HomeRF also belong to WLAN technology. The Bluetooth standard, however, is implemented and used within smaller radiuses than 802.11b. HomeRF has a substantially similar transmission radius as that of 802.11b.

Therefore, a need exists for a system and method of determining location information of a wireless mobile station without direct access to a satellite signal.

### SUMMARY OF THE INVENTION

According to an embodiment of the present invention, a wireless communication system obtains location information of a wireless mobile station that fails to receive a satellite signal.

According to an embodiment of the present invention, a method comprises determining location information of a wireless mobile station communicating with a wireless base station through a wireless communication network.

According to an embodiment of the present invention, a method comprises communicating between a wireless base station and a wireless mobile station and providing location information to a wireless mobile station.

According to an embodiment of the present invention, a wireless communication system comprises a wireless mobile station and a wireless base station for communicating with the wireless mobile station through a wireless communication network. The wireless mobile station requests the wireless base station to transmit location information, and the wireless base station transmits the location information to the wireless mobile station in response to the request of the wireless mobile station.

In a preferred embodiment, the wireless base station comprises a GPS receiver for receiving a satellite signal from a GPS satellite.

The wireless base station analyzes the satellite signal received from the GPS receiver in response to the request of the wireless mobile station, determines the location information and provides the determined location information to the wireless mobile station.

The signal transmitted and received between the wireless base station and the wireless mobile station satisfies IEEE 802.11 specification.

The wireless base station comprises a memory for storing the location information.

The wireless base station provides the wireless mobile station with the location information stored in the memory in response to the request of the wireless mobile station.

The wireless communication system further comprises a GPS base station for receiving a satellite signal from a GPS satellite, determining location information based on the received satellite signal, and transmitting the determined location information to the wireless base station through wire.

The wireless base station provides the wireless mobile station with the location information received from the GPS base station in response to the request of the wireless mobile station.

According to an embodiment of the present invention, there is provided a method of determining location information of a wireless mobile station. The wireless mobile station communicates with a wireless base station through a wireless communication network. The method comprises requesting the wireless base station to transmit the location information, receiving the location information from the wireless base station, estimating a distance between the wireless mobile station and the wireless base station, and determining a location from the received location information and the estimated distance.

The wireless base station comprises a GPS receiver for receiving a satellite signal from a GPS satellite.

Requesting the wireless base station to transmit the location information comprises determining whether the GPS receiver can access the satellite signal, and if the GPS receiver cannot access the satellite signal, requesting the wireless base station to transmit the location information.

The method further comprises requesting the wireless base station to transmit GPS information, and receiving the GPS information from the wireless base station. The signal transmitted and received between the wireless base station and the wireless mobile station satisfies IEEE 802.11 specification.

According to an embodiment of the present invention, a method in which a wireless base station communicates with a wireless mobile station through a wireless communication network provides location information to the wireless mobile station, the wireless mobile station being provided with a GPS receiver for receiving a satellite signal. The method comprises receiving location information request from the wireless mobile station, determining location information from the satellite signal received by the GPS receiver, and transmitting the determined location information to the wireless mobile station.

The method further comprises receiving GPS information request from the wireless mobile station, and transmitting the GPS information received from the GPS receiver to the wireless mobile station.

According to an embodiment of the present invention, a method in which a wireless base station communicates with a wireless mobile station through a wireless communication network, provides location information to the wireless mobile station, the wireless mobile station being provided with a memory storing location information. The method comprises receiving a location information request from the wireless mobile station, reading location information stored in the memory, and transmitting the read location information to the wireless mobile station.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating that a wireless base station and a wireless mobile station in wireless LAN environment communicate location information with each other in a communications system according to a preferred embodiment of the present invention;

FIG. 2 illustrates a connection between inner circuit configuration of the wireless base station and the wireless mobile station, according to an embodiment of the present invention;

FIG. 3 illustrates a GPS receiver in the wireless base station and a wireless transceiver sharing a processor and a memory, according to an embodiment of the present invention;

FIG. 4 is a flowchart illustrating a method of the wireless mobile station shown in FIGS. 1 and 2 for obtaining location information, according to an embodiment of the present invention;

FIG. 5 is a flowchart illustrating a method of the wireless base station shown in FIG. 2 for providing location information in response to request of the wireless mobile station, according to an embodiment of the present invention;

FIG. 6 is a schematic view illustrating that a wireless base station and a wireless mobile station in wireless LAN environment communicate location information with each other in a communication system according to an embodiment of the present invention;

FIG. 7 illustrates a CGPU interface provided in the wireless base station and a wireless transceiver sharing a processor and memory, according to an embodiment of the present invention;

FIG. 8 is a flowchart illustrating a method of the wireless base station illustrated in FIG. 6;

FIG. 9 illustrates a packet format transmitted and received between the wireless base station and the wireless mobile station, according to an embodiment of the present invention;

FIG. 10 illustrates another packet format transmitted and received between the wireless base station and the wireless mobile station, according to an embodiment of the present invention;

FIG. 11 illustrates IS-801 standard defining protocol which is used to transmitting and receiving GPS satellite information between a base station and a wireless mobile station by using data burst message of L3 message of CDMA 2000 specification;

FIG. 12 illustrates a communication system according to an embodiment of the present invention including a wireless base station without a GPS receiver and a wireless mobile station;

FIG. 13 illustrates a wireless base station provided with wireless transceiver without a processor, according to an embodiment of the present invention;

FIG. 14 is a flowchart illustrating operation steps of the wireless base station shown in FIG. 13; and

FIG. 15 illustrates a communication system of blue-tooth environment according to an embodiment of the present invention.

### DETAILED DESCRIPTION OF PREFERRED EMBODIMENTS

Reference will now be made in detail to preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention.

Preferred embodiments will be described in detail referring to the accompanied drawings.

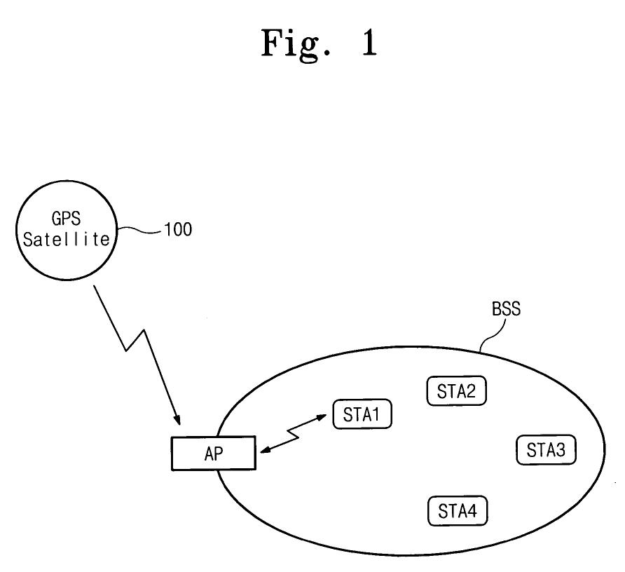

FIG. 1 is a schematic view illustrating that a wireless base station, or access point (AP), and wireless mobile stations STA1-STA4 in wireless LAN environment communicate location information with each other in a communications system according to a preferred embodiment of the present invention. A wireless mobile station may be, for example, a laptop computer, a notebook personal computer, a desktop computer, a personal digital assistant (PDA) or a barcode scanner. The wireless base station AP connects a plurality of wireless mobile stations STA1-STA4 in a basic service set (BSS) to a wired network.

According to the IEEE 802.11 specification, the wireless base station AP can also be a wireless mobile station or a fixed wireless base station AP. If any one of the wireless mobile stations STA1-STA4 requests location information, the wireless base station AP analyses a satellite signal received from a GPS satellite 100, determines its location information and transmits the determined location information to the wireless mobile stations STA1-STA4. The wireless mobile station that requests the location information estimates its distance to the wireless base station AP and can determine its own location based on the estimated distance and the location information received from the wireless base station AP.

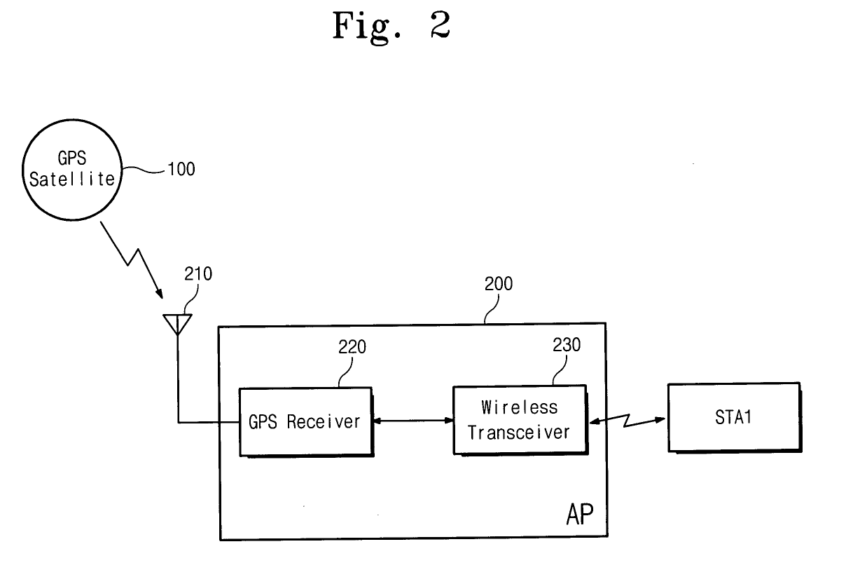

FIG. 2 illustrates a connection between an inner circuit configuration of the wireless base station and the wireless mobile station. Referring to FIG. 2, the wireless base station AP 200 includes a GPS receiver 220 connected to a GPS antenna 210 and a wireless transceiver 230. The GPS receiver 230 analyzes the satellite signal received from the GPS satellite 100 through the GPS antenna 210, determines the location information and provides the determined location information to the wireless transceiver 230. The wireless transceiver 230 constructs a packet satisfying the IEEE 802.11 specification from the location information received from the GPS receiver 220 and transmits the packet to the wireless mobile station STA1. The GPS receiver 220 and the wireless transceiver 230 shown in FIG. 2 comprise a system-on-a-chip (SOC) into which a processor, a memory, and input/output interface are integrated.

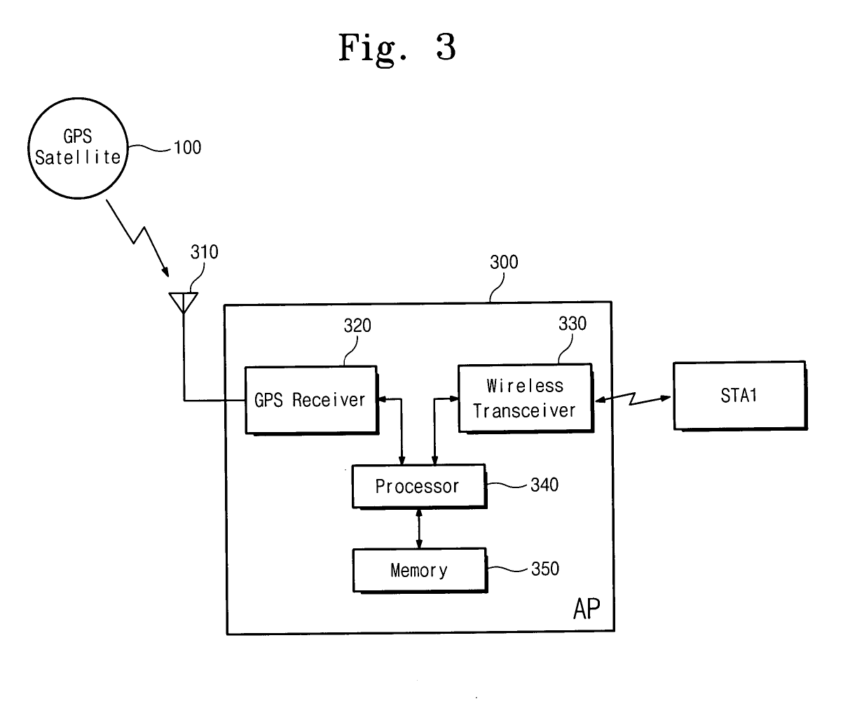

FIG. 3 illustrates a wireless base station AP 300 comprising a GPS receiver 320 and a wireless transceiver 330 sharing a processor 340 and a memory 350. Referring to FIG. 3, the GPS receiver 320 and the wireless transceiver 330 do not include a processor, unlike the GPS receiver 220 and the wireless transceiver 230 shown in FIG. 2. Accordingly, the GPS receiver 320 receives the satellite signal from the GPS satellite 100 through the antenna 310 and transmits the satellite signal to the processor 340. The processor 340 analyzes the satellite signal received from the GPS receiver 320, determines the location information and provides the determined location information to the wireless transceiver 330. The wireless transceiver 330 constructs a packet from the location information received from the processor 340 and transmits the packet to the wireless mobile station STA1.

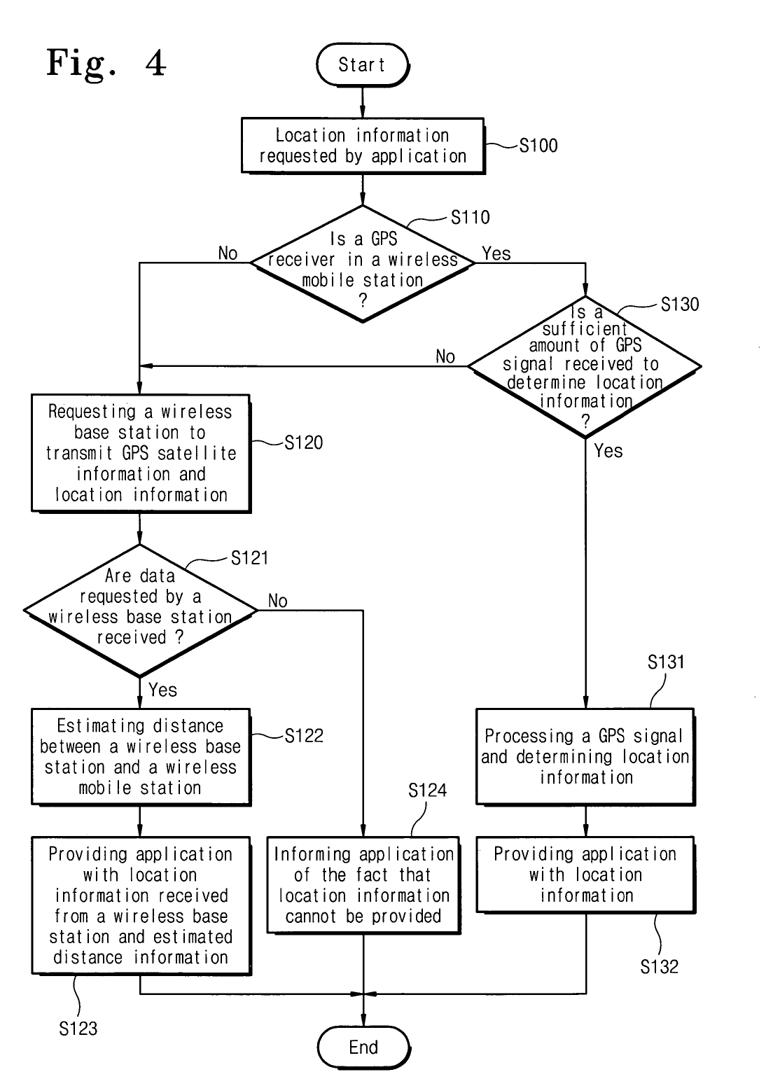

FIG. 4 is a flowchart illustrating a method by which the wireless mobile station STA1 shown in FIGS. 1 and 2 obtains location information. At step S100, an application requests location information from the wireless mobile station STA1. At step S110, the wireless mobile station STA1 determines whether a GPS receiver is installed. If the GPS receiver is installed, the wireless mobile station STA1 performs step S130. At the step S130, the wireless mobile station STA1 determines whether a sufficient amount of GPS signal has been received to determine location information. Upon determining that the GPS signal is received, at step S131, the wireless mobile station STA1 processes the satellite signal received from a GPS satellite to determine location information. At step S132, the wireless mobile station STA1 provides the application with the determined location information.

At step S110, if the GPS receiver is not installed, the wireless mobile station STA1 utilizes a wireless base station AP for GPS satellite information and/or location information at step S120. At step S121, the wireless mobile station STA1 determines whether the GPS satellite information and/or the location information are/is received from the wireless base station AP. If the GPS satellite information and/or the location information are/is received from the wireless base station AP, the wireless mobile station STA1 estimates a distance between the wireless base station AP and the wireless mobile station STA1 at step S122. The method of estimating the distance between the wireless base station AP and the wireless mobile station STA1 is exemplified by signal strength analysis, time of arrival (TOA), etc. The signal strength analysis measures an intensity of the signal that is transmitted from the wireless base station AP and arrives at the wireless mobile station STA1 and determines the distance between the wireless base station AP and the wireless mobile station STA1. A TOA determination comprises analyzing the elapsed time of the data transmitted from the wireless base station AP and arriving at the wireless mobile station STA1.

At step S123, the wireless mobile station STA1 provides the application with the location information received from the wireless base station AP and the estimated distance information. Or, the wireless mobile station STA1 determines a location based on the location information received from the wireless base station AP and the estimated distance information and provides the application with the determined location.

At step S121, if the signal indicating that the wireless base station AP cannot provide the location information is received, the wireless mobile station STA1 informs the application of the fact that the location information cannot be provided at step S124.

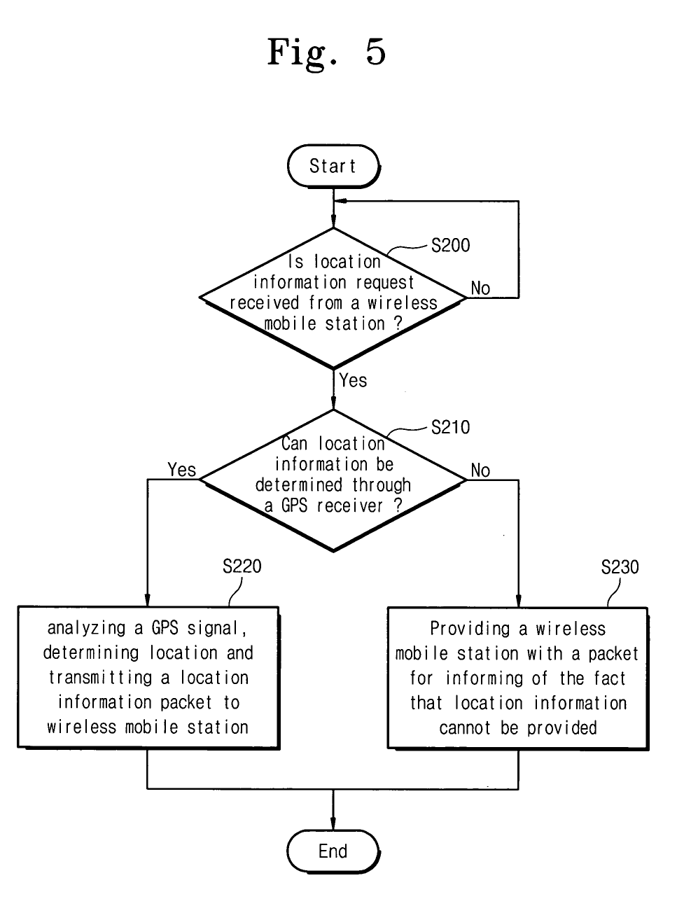

FIG. 5 is a flowchart illustrating a method of the wireless base station AP shown in FIG. 2 for providing location information in response to a request of the wireless mobile station. Referring to FIG. 5, at step S200, the wireless base station AP determines whether a location information request is received from the wireless mobile station STA1. If the location information request is received from the wireless mobile station STA1, the wireless base station AP performs step S210.

At step S210, the wireless base station AP determines whether the location information can be determined by the GPS receiver 220. If the location information can be determined based on the satellite signal received from the GPS satellite 100 the wireless base station AP performs step S220. At step S220, the GPS receiver 200 of the wireless base station AP analyzes a satellite signal received from the GPS satellite 100, determines location information, and transmits the determined location information to the wireless transceiver 230. The transceiver 230 constructs a packet satisfying the IEEE 802.11 specification from the location information and transmits the packet to the wireless mobile station STA1.

At step S210, a satellite signal strength is determined and if the GPS receiver 220 cannot receive the satellite signal, to the wireless base station AP performs step S230. At the step S230, the wireless base station AP constructs a packet from the signal for informing the wireless mobile station STA1 of the fact that the location information cannot be provided and transmits the packet to the wireless mobile station STA1.

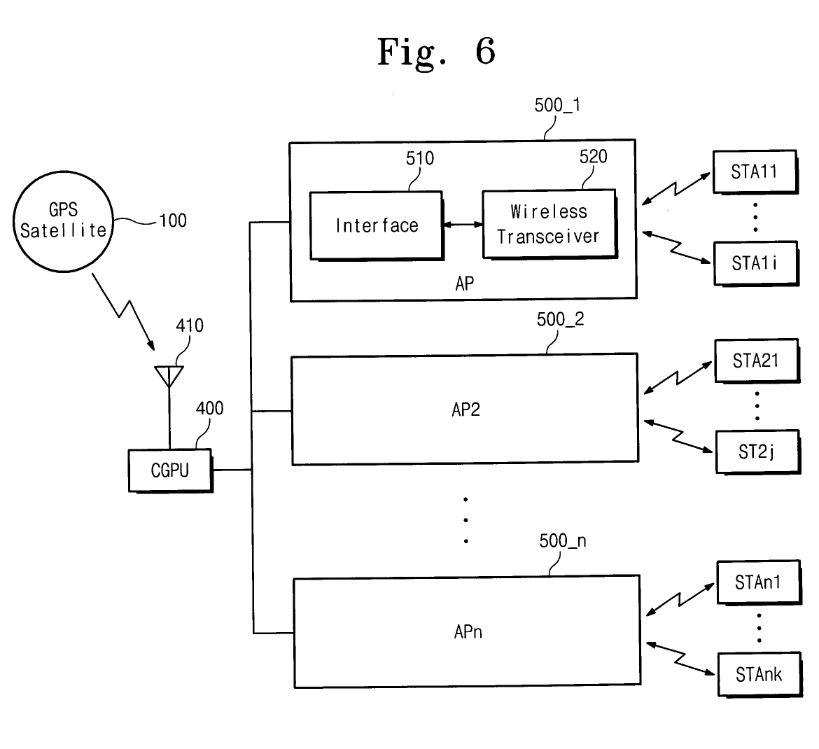

FIG. 6 is a schematic view illustrating that a wireless base station AP and wireless mobile stations STA1-STA4 in wireless LAN environment communicate location information with each other in a communications system according to an embodiment of the present invention. Referring to FIG. 6, the wireless base stations 500_1-500_{—}n are connected to a central GPS processing unit (CGPU) 400 through wires. The CGPU 400 is provided with an antenna 410 for receiving the satellite signal from the GPS satellite 100. Each wireless base station 500_1-500_{—}n includes a CGPU interface 510 and a wireless transceiver 520. The CGPU 400 includes an interface and a wireless transceiver, and analyzes a satellite signal received through an antenna 410, determines GPS information and location information and transmits the determined GPS information and location information to the wireless base stations 500_1-500_{—}n. Each of the wireless base stations 500_1-500_{—}n communicates with a plurality of wireless mobile stations. In other words, the wireless base station 500_1 communicates with the wireless mobile stations STA11-STA1i. The wireless base station 500_2 communicates with the wireless mobile stations STA21-STA2j. The wireless base station 500_{—}n communicates with the wireless mobile stations STAn1-STAnk.

For instance, when the wireless mobile station STA11 requests the wireless base station AP1 to transmit location information, the wireless base station 500_1 operates as follows. The CGPU interface 510 of the wireless base station AP1 transmits the GPS information and the location information that are received from the CGPU 400 and stored in a built-in memory (not shown) to the wireless transceiver 520. The wireless transceiver 520 constructs a packet from the GPS information and the location information and transmits the packet to the wireless mobile station STA11.

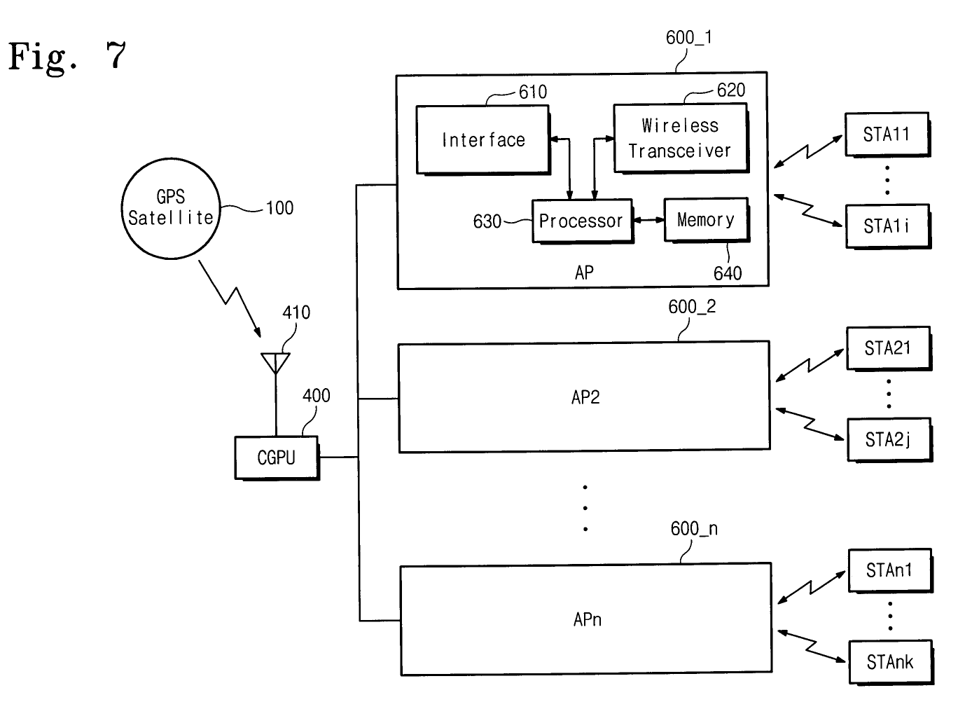

FIG. 7 illustrates a wireless base station 600_1 comprising a CGPU interface 610 a wireless transceiver 620 sharing a processor 630 and memory 640. Referring to FIG. 7, each of the wireless base stations 600_1-600_{—}n includes a CGPU interface 610, a wireless transceiver 620, a processor 630, and a memory 640. The processor 630 stores GPS information and location information that are received from the CGPU 410 through the CGPU interface 610 in a memory 640, and transmits the GPS information and the location information stored in the memory 640 to the wireless mobile station through the wireless transceiver 620 when the location information is requested by any one of the wireless mobile stations STA11-STA1i.

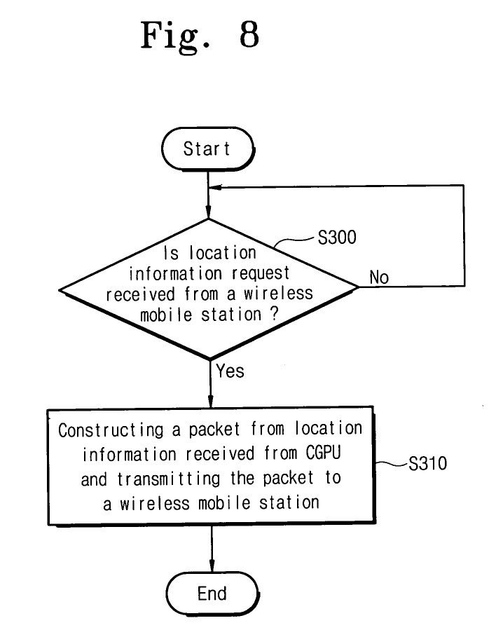

FIG. 8 is a flowchart illustrating a method of the wireless base station illustrated in FIG. 6. At step S300, the wireless base station 500 determines whether a location information request is received from the wireless mobile stations STA11-STA1i. If the location information request is received from the wireless mobile stations STA11-STA1i, the wireless base station performs step S310. At the step S310, the wireless base station 500 constructs a packet from the location information provided from the CGPU 400 and transmits the packet to the wireless mobile station that requested the location information.

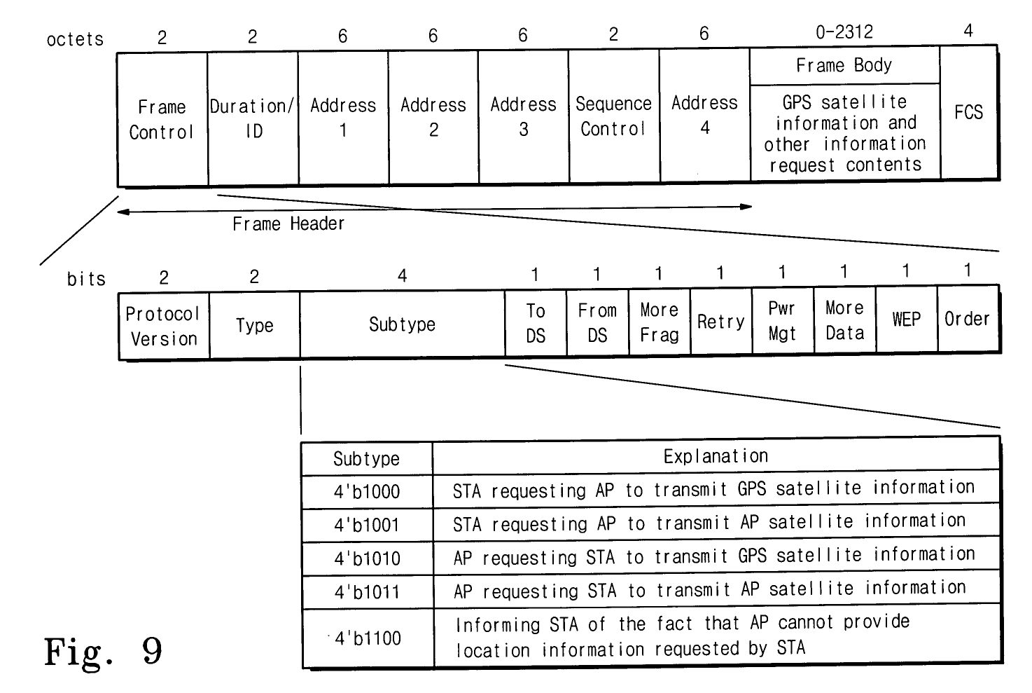

FIG. 9 illustrates a packet format transmitted and received between the wireless base station and the wireless mobile station. According to the IEEE 802.11 specification, in a medium access control (MAC) frame, the subtype of frame control region comprises four bits and the frame body comprises 2,312×8 bits, that is, 18,496 bits. In the example shown in FIG. 9, the type indicating the location information request or response is defined in the subtype. The frame body includes the location information or response contents. For example, when the wireless mobile station requests the wireless base station to transmit GPS information, the subtype includes ‘1000’. When the wireless base station provides the wireless mobile station with GPS satellite information, the subtype includes ‘1010’ and the frame body includes the GPS satellite information. When the wireless mobile station requests the wireless base station to transmit the location information, the subtype includes ‘1001’. When the wireless base station provides the wireless mobile station with the location information, the subtype includes ‘1001’ and the frame body includes the location information.

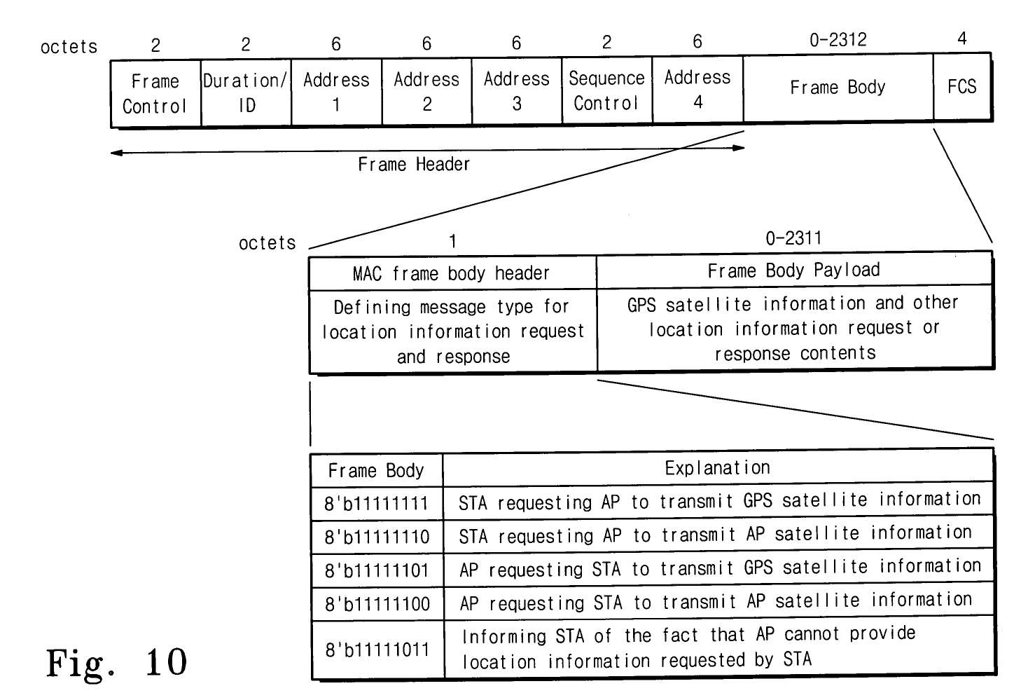

FIG. 10 illustrates another packet format transmitted and received between the wireless base station and the wireless mobile station. Referring to FIG. 10, the type indicating location information request or response is defined on upper 8 bits of a body region, or a header, and the remaining 2311×8 bits includes location information or request contents. For example, when the wireless mobile station requests the wireless base station for GPS information, the header includes ‘11111111’. When the wireless base station provides the wireless mobile station with GPS satellite information, the subtype includes ‘11111101’ and the frame body includes the GPS satellite information. When the wireless mobile station provides the wireless base station with GPS satellite information, the subtype includes ‘11111101’ and the frame body includes the GPS satellite information. When the wireless mobile station requests the wireless base station to transmit location information, the subtype includes ‘11111110’. When the wireless base station provides the wireless mobile station with location information, the subtype includes ‘11111100’ and the frame body includes the location information. When the wireless base station cannot provide the wireless mobile station with location information though the wireless mobile station requests the wireless base station to transmit the location satellite information, the subtype includes ‘11111011’.

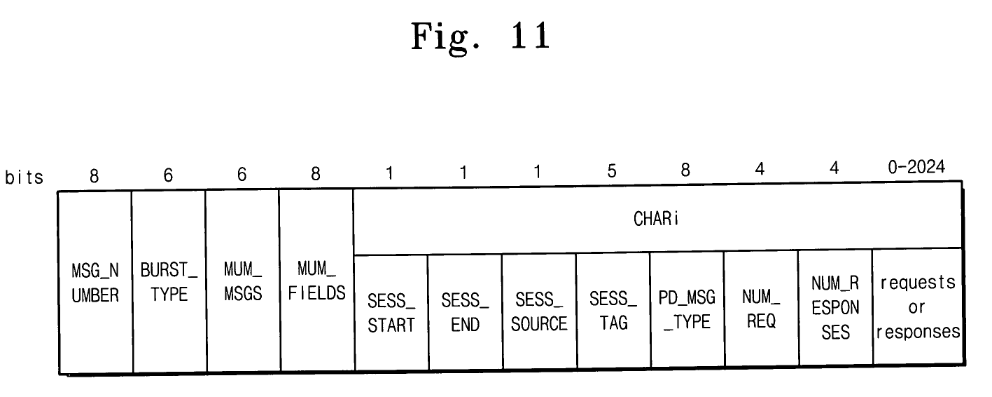

FIG. 11 illustrates the IS-801 standard defining protocol that is used to transmit and receive GPS satellite information between a base station and a wireless mobile station using a data burst message of an L3 message of the CDMA 2000 specification. According to the IS-801 standard, all the information is represented by at most 270 bytes (2,156 bits). According to the IEEE 802.11 specification, the maximum frame length of medium access control (MAC) message that can be transmitted and received between the wireless base station and the wireless mobile station is 2,346 bytes including a header and the frame body, or 2,312 bytes excluding the header and the frame body. Therefore, the information of the 270 bytes defined by the IS-801 standard can be transmitted in the frame body according to the IEEE 802.11 specification. Therefore, the location information and the GPS satellite information are constructed in the method defined by the IS-801 standard and the packet transmitted and received between the wireless base station and the wireless mobile station can be defined.

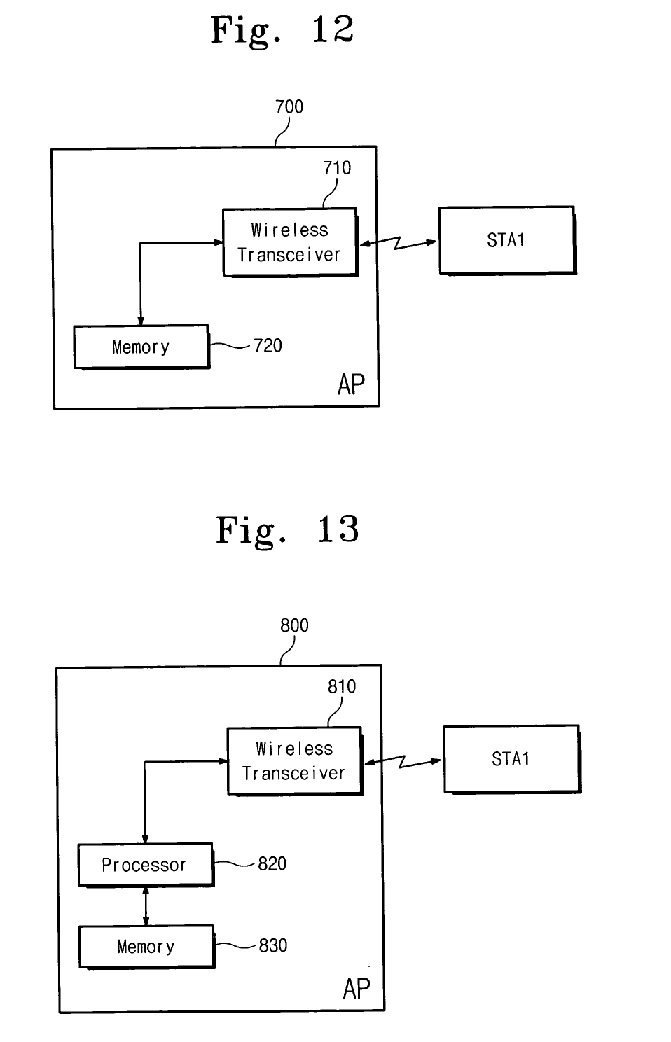

FIG. 12 illustrates a communications system according to an embodiment of the present invention including a wireless base station without a GPS receiver and a wireless mobile station. Referring to FIG. 12, the wireless base station 700 includes a memory 720 for storing the location information thereof. The wireless transceiver 710 in the wireless base station 700 provides the wireless mobile station STA1 with the location information thereof stored in the memory 720 when the location information request is received from the wireless mobile station STA1.

A wireless transceiver 810 of a wireless base station 800 shown in FIG. 13 does not include an SOC processor such as that of the wireless transceiver 710. Therefore, the wireless base station 800 further includes a processor 820. When the wireless transceiver 810 receives the location information request from the wireless mobile station STA1, the location information is requested from the processor 820. The processor 820 transmits the location information stored in the memory 830 to the wireless transceiver 810 in response to the request of the wireless transceiver 810. The wireless transceiver 810 constructs a packet from the location information provided through the processor 820 and transmits the packet to the wireless mobile station STA1.

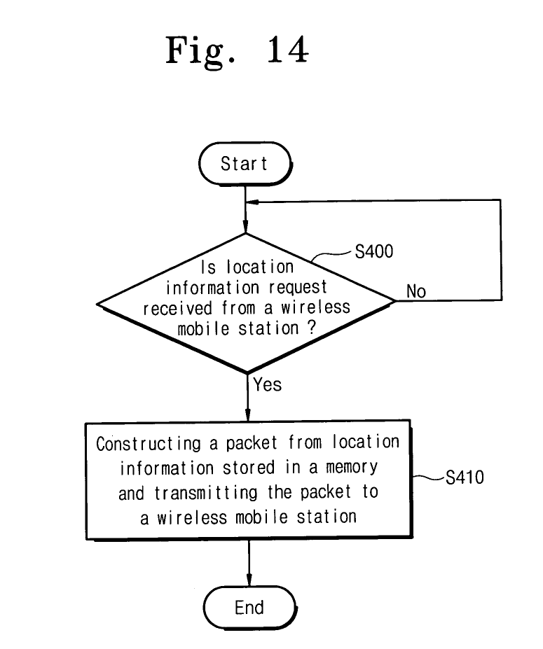

FIG. 14 is a flowchart illustrating operation steps of the wireless base station 700 shown in FIG. 13. At step S400, the transceiver 710 determines whether location information request is received from the wireless mobile station STA1. If the location information request is received, the wireless base station performs step S410. At the step S410, the wireless transceiver 710 reads the location information stored in the memory, constructs a packet from the read location information, and transmits the packet to the wireless mobile station STA1.

In the description of the present invention, the communications system of the wireless LAN environment was described as an example but it can be adapted to various communication environments.

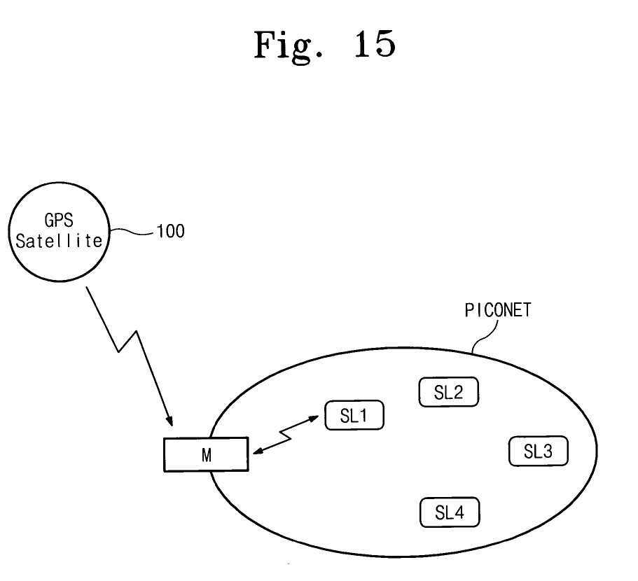

FIG. 15 illustrates a communications system of blue-tooth environment according to an embodiment of the present invention. The slave devices SL1-SL4 in PICONET communicate wirelessly with a master device M in the manner defined by Bluetooth. The master device M includes a GPS receiver (not shown) for receiving a satellite signal from the GPS satellite 100. An antenna (not shown), connected to the GPS receiver, is installed so as to receive the satellite signal, e.g., outside a building. When the master device M receives the location information request from any one of the slave devices SL1-SL4, the master device M provides the corresponding slave device with the location information thereof provided from the GPS satellite 100. Therefore, even though the slave devices SL1-SL4 are installed indoor where the satellite signal cannot be received from the GPS satellites 100, the location of the slave device can be found through the master device M.

Though the present invention was described using exemplary preferred embodiments, it is well understood that the scope of the present invention is not limited by the disclosed embodiments. Furthermore, the scope of the present invention is intended to cover the modifications and variations of the present invention. Accordingly, the claims should be interpreted to cover all the modifications and variations of the present invention.

According to the present invention, although the mobile station is placed in an environment in which it is difficult to receive a satellite signal or the mobile station does not include a satellite signal receiver, the location of the mobile station can be determined through the base station that can receive a GPS satellite signal.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A wireless communication system comprising:
a wireless mobile station; and
a wireless base station coupled with the wireless mobile station through a wireless communication network,
wherein the wireless base station transmits location information to the wireless mobile station in response to a request of the wireless mobile station.

2. The wireless communication system of claim 1, wherein the wireless base station comprises a receiver for receiving a satellite signal from a satellite.

3. The wireless communication system of claim 2, wherein the wireless base station analyzes the satellite signal in response to the request of the wireless mobile station, determines the location information and provides the determined location information to the wireless mobile station.

4. The wireless communication system of claim 1, wherein the signal transmitted and received between the wireless base station and the wireless mobile station satisfies IEEE 802.11 specification.

5. The wireless communication system of claim 1, wherein the wireless base station comprises a memory for storing the location information.

6. The wireless communication system of claim 5, wherein the wireless base station provides the wireless mobile station with the location information stored in the memory in response to the request of the wireless mobile station.

7. The wireless communication system of claim 1, further comprising:
a base station for receiving a satellite signal from a satellite, determining location information according to the received satellite signal, and transmitting the determined location information to the wireless base station through wire.

8. The wireless communication system of claim 7, wherein the wireless base station provides the wireless mobile station with the location information received from the base station in response to the request of the wireless mobile station.

9. A method of determining location information of a wireless mobile station, wherein the wireless mobile station is coupled with a wireless base station through a wireless communication network, the method comprising:
requesting location information from the wireless base station;
receiving the location information from the wireless base station;
estimating a distance between the wireless mobile station and the wireless base station; and
determining a location from the received location information and the estimated distance.

10. The method of claim 9, further comprising receiving a satellite signal from a satellite at a receiver of the wireless base station.

11. The method of claim 9, requesting location information comprises:
determining whether the receiver can access the satellite signal; and
requesting the wireless base station to transmit the location information upon determining that the receiver cannot access the satellite signal.

12. The method of claim 10, further comprising:
requesting the wireless base station to transmit information; and
receiving the information from the wireless base station.

13. The method of claim 12, wherein the signal transmitted and received between the wireless base station and the wireless mobile station satisfies IEEE 802.11 specification.

14. A method in which a wireless base station communicates with a wireless mobile station through a wireless communication network to provide location information to the wireless mobile station, the wireless mobile station being provided with a GPS receiver for receiving a satellite signal, the method comprising:
receiving a location information request from the wireless mobile station;
determining the location information from the satellite signal received by the GPS receiver; and
transmitting the determined location information to the wireless mobile station.

15. The method of claim 14, further comprising:
receiving an information request from the wireless mobile station; and
transmitting the information received from the GPS receiver to the wireless mobile station.

16. A method in which a wireless base station communicates with a wireless mobile station through a wireless communication network to provide location information to the wireless mobile station, the wireless mobile station being provided with a memory storing location information, the method comprising:
receiving a location information request from the wireless mobile station;
reading location information stored in the memory; and
transmitting the read location information to the wireless mobile station.
